(19) United States
(12) Patent Application Publication
(10) Pub. No.: US 2010/0267537 A1
(43) Pub. Date: Oct. 21, 2010

(54) CHARGING ROLL AND METHOD OF PRODUCING THE SAME

(75) Inventors: Shinkichi KASHIHARA, Konan-Shi (JP); Atsuhiro Kawano, Kasugai-Shi (JP); Yoshihiro Saito, Hamamatsu-Shi (JP)

Correspondence Address: BURR & BROWN, PO BOX 7068, SYRACUSE, NY, 13261-7068, US

(73) Assignee: Tokai Rubber Industries, Ltd., Komaki-Shi (JP)

(21) Appl. No.: 12/758,178

(22) Filed: Apr. 12, 2010

(30) Foreign Application Priority Data
Apr. 15, 2009 (JP) 2009-098858
Dec. 25, 2009 (JP) 2009-293761

(51) Int. Cl. B05C 1/08; B05D 5/12; G03G 15/02

(52) U.S. Cl. 492/18; 399/176; 427/58

(57) ABSTRACT

A charging roll is provided which does not cause image defects even when being used for a long period of time and does not allow a surface layer to be separated when an electrophotographic machine is operated after the charging roll installed therein is left under high temperature and humidity conditions. A charging roll includes a shaft, an electrically conductive rubber foam layer formed on an outer circumferential surface of the shaft, and a surface layer formed radially outwardly of the electrically conductive rubber foam layer. The electrically conductive rubber foam layer includes a skin layer having an opening area ratio of from 0.5 to 20% at a superficial layer of the electrically conductive rubber foam layer, and the surface layer is formed of a synthetic resin composition mainly composed of a synthetic resin material having a glass transition temperature of from 0 to 45° C.

The present application is based on Japanese Patent Application Nos. 2009-098858 and 2009-293761 filed on Apr. 15, 2009 and Dec. 25, 2009, respectively, the contents of which are incorporated herein by reference.

### BACKGROUND OF THE INVENTION

1. Field of the Invention

The present invention relates to a charging roll for use in an image forming apparatus such as an electrophotographic copier, printer, or facsimile machine. In particular, the invention is concerned with such a charging roll for charging an image-bearing medium such as a photoconductive or photosensitive medium used in electrophotography, and a dielectric medium used in electrostatic recording.

2. Description of the Related Art

In an image forming apparatus (hereinafter, referred to as an electrophotographic machine) such as an electrophotographic copier, printer, or facsimile machine, a so-called roll charging method has been widely adopted, in which a charging roll and an image-bearing medium such as a photosensitive drum are mutually rotated, while the image-bearing medium is held in contact with an outer circumferential surface of the charging roll, thereby charging the surface of the image-bearing medium.

As charging rolls for use in the roll charging method, charging rolls with various structures have been conventionally suggested and used. For example, Japanese Patent No. 3277619 discloses a charging roll that includes a conductive shaft (metal core), an electrically conductive rubber foam layer formed of an electrically conductive rubber foam having low hardness, which is provided as a base layer on an outer circumferential surface of the conductive shaft, and a surface layer (protective layer) formed radially outwardly of the electrically conductive rubber foam layer.

However, when the surface layer of the charging roll having the above structure is formed of a synthetic resin composition (formation material of a surface layer) including a hard synthetic resin material (a synthetic resin material having a high glass transition temperature) as a main component, the charging roll to be obtained suffers from the following problems due to the high hardness of the charging roll. Specifically, the charging roll having high hardness is pressed harder to (residual) toner remaining on the surface of the image-bearing medium such as a photosensitive drum. Therefore, when the charging roll is used for a long period of time, toner is adhered to the surface of the charging roll and undesirable lines appear on the surface of the charging roll in a circumferential direction thereof. Due to the lines appeared on the surface of the charging roll, quality of the image to be printed is undesirably deteriorated.

To solve the above problems, a synthetic resin composition including a soft synthetic resin material (a synthetic resin material having a low glass transition temperature) as a main component may be used as a material for a surface layer.

However, in the case of a charging roll including a surface layer formed of a synthetic resin composition including a soft synthetic resin material (a synthetic resin material having a low glass transition temperature) as a main component, the surface layer of the charging roll adheres to a surface of a photosensitive drum, for example, when the charging roll is left under high temperature and humidity conditions for a long period of time while the charging roll is held in contact with an image-bearing medium such as a photosensitive drum in an electrophotographic machine. Therefore, the surface layer of the charging roll may be separated when the machine is used.

In recent years, there are widely employed cartridges having a structure in which a charging roll and an image-bearing medium are accommodated in a prescribed box while an outer circumferential surface of the charging roll is held in contact with a surface of the image-bearing medium. Due to this structure, the charging roll can be easily installed in and removed from an electrophotographic machine. Such cartridges are called process cartridges or drum cartridges, for example. Further, there are employed cartridges including a toner container (storage) and an image developing roll in addition to the charging roll. Such cartridges are called toner cartridges, for example. The cartridges including the above-described charging rolls also have the above-described problems.

The inventors speculate that such separation is caused by 1) low adhesion between the electrically conductive rubber foam layer and the surface layer of the charging roll, 2) low friction between the electrically conductive rubber foam layer and the surface layer at the time of operation of the electrophotographic machine, and etc.

### SUMMARY OF THE INVENTION

The present invention has been made in the light of the situation described above. It is therefore an object of the invention to provide a charging roll that prevents a printed or reproduced image from suffering from defects even when the charging roll is used for a long period of time and prevents a surface layer from separating when an electrophotographic machine is operated after the charging roll is left under high temperature and humidity conditions while being installed in an electrophotographic machine. It is another object of the present invention to provide a method of producing such a charging roll.

It is therefore an object of the present invention to provide a charging roll comprising a shaft, an electrically conductive rubber foam layer formed on an outer circumferential surface of the shaft, and a surface layer formed radially outwardly of the electrically conductive rubber foam layer, in which the electrically conductive rubber foam layer includes a skin layer having an opening area ratio of from 0.5 to 20% at a superficial layer of the electrically conductive rubber foam layer, and the surface layer is formed of a synthetic resin composition mainly composed of a synthetic resin material having a glass transition temperature of from 0 to 45° C.

According to a preferable aspect of the charging roll of the present invention, the electrically conductive rubber foam layer is formed by heating a semi-vulcanized, unfoamed rubber layer under ordinary pressure, the semi-vulcanized, Unfoamed Rubber Layer being Obtained by Heating an Unvulcanized, Unfoamed Rubber layer under pressure.

According to a preferable aspect of the charging roll of the present invention, the synthetic resin composition is in a liquid form.

It is another object of the present invention to provide a method of producing a charging roll including a shaft, an electrically conductive rubber foam layer formed on an outer circumferential surface of the shaft, and a surface layer formed radially outwardly of the electrically conductive rubber foam layer, characterized by the steps of: 1) providing an unvulcanized, unfoamed rubber layer which gives the electrically conductive rubber foam layer, 2) heating the unvulcanized, unfoamed rubber layer under pressure to obtain a semi-vulcanized, unfoamed rubber layer including a skin layer at a superficial layer thereof, 3) heating the semi-vulcanized, unfoamed rubber layer under ordinary pressure to allow the skin layer to have openings, thereby obtaining the electrically conductive rubber foam layer including the skin layer having an opening area ratio of from 0.5 to 20% at the superficial layer of the electrically conductive rubber foam layer, and 4) forming the surface layer by a synthetic resin composition mainly composed of a synthetic resin material having a glass transition temperature of from 0 to 45° C., so as to be positioned radially outwardly of the electrically conductive rubber foam layer.

As described above, the surface layer as an outermost layer of the charging roll according to the present invention is formed of the synthetic resin composition mainly composed of a synthetic resin material having a glass transition temperature of from 0 to 45° C., so that hardness thereof is relatively low. Accordingly, even when toner remain on a surface of the image-bearing medium such as a photosensitive drum due to a long period of use, load to be applied to the toner is effectively reduced. As a result, generation of stain caused by the adhesion of toner on the charging roll surface can be advantageously prevented, thus defects of the printed image can be effectively prevented.

Further, the surface layer of the charging roll according to the present invention is formed radially outwardly of the electrically conductive rubber foam layer which includes, at a superficial layer thereof, the skin layer having an opening area ratio of from 0.5 to 20%, so that an area of contact between the surface layer and the electrically conductive rubber foam layer is sufficiently secured. As a result, even when the electrophotographic machine is operated after the charging roll of the present invention is left under high temperature and humidity conditions while being installed in the electrophotographic machine (cartridge), the surface layer of the charging roll can be prevented from separating.

Further, according to the method of producing the charging roll of the present invention, the charging roll having the above-described characteristics can be advantageously produced.

### BRIEF DESCRIPTION OF THE DRAWING

The above and other objects, features, advantages and technical and industrial significance of the present invention will be better understood by reading the following detailed description of a presently preferred embodiment of the invention, when considered in connection with the accompanying drawing, in which:

FIG. 1 is a cross section taken in a plane perpendicular to the axis, showing one embodiment of a charging roll according to the present invention.

### DETAILED DESCRIPTION OF THE INVENTION

To further clarify the present invention, there will be described in detail an embodiment of the invention with reference to the accompanying drawing.

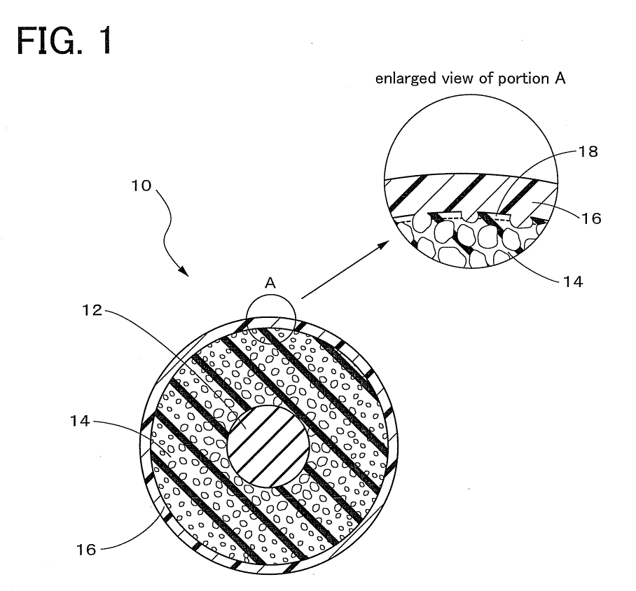

Referring to FIG. 1, one representative example of a charging roll according to the present invention is schematically shown in a cross section taken in a plane perpendicular to its axis. In FIG. 1, the charging roll 10 includes an electrically conductive center shaft (a core metal) 12 made of metal, an electrically conductive rubber foam layer 14 constituting a base layer, and a surface layer (a protective layer) 16 constituting an outermost layer. The electrically conductive rubber foam layer 14 and the surface layer 16 having respective suitable thickness are formed in layers radially outwardly of the electrically conductive center shaft 12 in the order of description.

The electrically conductive center shaft 12 used herein is not particularly limited as long as it is made of metal having conductivity. Examples of the metals include iron, stainless steel (SUS defined in JIS), and free cutting steel (SUM defined in JIS). The electrically conductive center shaft 12 may be plated, for example. Further, adhesive, primer or the like may be applied on the outer circumferential surface of the electrically conductive center shaft 12 as needed. The shape of the electrically conductive center shaft 12 may be a pipe shape having a cylindrical hollow body other than the rod shape having the solid body as shown in FIG. 1.

The first characteristic of the charging roll 10 according to the present invention is that the electrically conductive rubber foam layer 14 includes a skin layer 18 having an opening area ratio of from 0.5 to 20% at a superficial layer of the electrically conductive rubber foam layer 14. Due to the presence of the skin layer (18) having an opening area ratio within a predetermined range at the superficial layer of the electrically conductive rubber foam layer (14), the charging roll (10) of the present invention can sufficiently have an area of contact between the electrically conductive rubber foam layer (14) and the surface layer (16). Accordingly, the surface layer (16) is advantageously prevented from separating even when an electrophotographic machine is operated after the charging roll (10) of the present invention is left under high temperature and humidity conditions while being installed in the electrophotographic machine (cartridge).

Here, the opening area ratio (%) used in this specification and claims are calculated as follows. Measurement of the opening area is conducted on the electrically conductive rubber foam layer before the surface layer is formed thereon. Specifically, the measurement is conducted on three parts of the electrically conductive rubber foam layer, a center part and each end part in its axial direction, three times on each part by using an optical microscope such as a laser microscope. That is, the measurement is conducted nine times. The measured opening area is divided by the observation area of the optical microscope, thereby obtaining an opening area ratio (%) of one measurement. Then, an average is calculated by using the opening area ratios (%) obtained by nine measurements. This average is used as an opening area ratio (%) in this specification and claims. It is to be noted that it is based on the premise that the maximum diameter of the opening is 250 μm or less.

In the charging roll, if the opening area ratio of the skin layer (18) of the electrically conductive rubber foam layer (14) is too low, the area of contact between the electrically conductive rubber foam layer (14) and the surface layer (16) cannot be sufficiently secured. Thus, the object of the present invention may not be effectively obtained. On the other hand, if the opening area ratio of the skin layer (18) is too high, it may be difficult to form the surface layer (16), or the thickness of the surface layer (16) may be uneven, which results in defects of the printed image. Accordingly, in the charging roll (10) of the present invention, an opening area ratio of the skin layer (18) of the electrically conductive rubber foam layer (14) is controlled to be in a range of from 0.5 to 20%.

In the present invention, in the formation of the electrically conductive rubber foam layer (14) including the skin layer (18) having a predetermined opening area ratio, a foamable conductive rubber composition mainly composed of various rubber materials is used. Examples of the rubber materials used in the present invention include epichlorohydrin rubber (ECO, CO, for example), nitrile rubber (NBR), ethylene-propylene diene rubber (EPDM), silicone rubber, urethane rubber, styrene-butadiene rubber (SBR), isoprene rubber (IR), chloroprene rubber (CR), and natural rubber (NR). Any one of theses rubber materials may be used alone, or any combination of theses rubber materials may be used. In the present invention, epichlorohydrin rubber and nitrile rubber, which are ion-conductive rubbers, are favorably used in order to advantageously equalize the distribution of electric resistance of the resultant charging roll.

Just like the conventional method, foaming agent, conductive agent, and additives such as filler, weighting agent, strengthening agent, processing agent, curing agent, vulcanizing agent, vulcanization accelerator, vulcanizing aid, antioxidant, plasticizer, ultraviolet absorbing agent, pigment, silicone oil and surfactant may be suitably added to the rubber material depending on the needs, without deteriorating the object of the present invention. Especially, determination of kinds and amounts of foaming agent, vulcanizing agent and vulcanization accelerator are important, because it has an effect on the formation of the skin layer (18) which is conducted by the heating under pressure and it also has an effect on the formation of openings of the skin layer (18) which is conducted by the heating under ordinary pressure.

For example, as a foaming agent, a well-known inorganic foaming agent or a well-known organic foaming agent may be added. In the present invention, an organic foaming agent is advantageously used because it can readily foam by thermal decomposition, and the decomposed product is excellent in compatibility with a rubber material as a matrix. Examples of the organic foaming agents include azodicarbonamide (ADCA), 4,4′-Oxybis(benzenesulfonyl hydrazide) (OBSH), and N,N′-dinitrosopentamethylene tetramine (DPT).

Further, examples of the conductive agents include carbon blacks such as Ketjenblack and acetylene black, graphite, metal powder, electrically conductive metal oxide, and ion-conductive agent such as quaternary ammonium salts such as trimethylammonium perchlorate, trimethyloctadecyl ammonium perchlorate and benzyltrimethylammonium chloride.

Then, a surface layer (16) is formed radially outwardly of the electrically conductive rubber foam layer (14) formed of the above-described foamable conductive rubber composition. The second characteristic of the charging roll according to the present invention is that the surface layer (16) is formed of a synthetic resin composition mainly composed of the synthetic resin material having a glass transition temperature of from 0 to 45° C.

Specifically, when the surface layer (16) of the charging roll (10) is formed of the synthetic resin composition mainly composed of the synthetic resin material having a glass transition temperature within a predetermined range, hardness of the produced surface layer (16) can be sufficiently low. As a result, even when the charging roll (10) of the present invention having such a surface layer is used for a long period of time in an electrophotographic machine, load to be applied to the toner remaining on a surface of the image-bearing medium such as a photosensitive drum can be advantageously reduced, thereby effectively preventing the generation of stain caused by the toner adhered onto a surface of the charging roll (10). Accordingly, defects of the printed image can be effectively prevented. Here, in this specification and claims, the glass transition temperature (° C.) is a temperature measured in accordance with a DSC method defined in JIS-C-6481: 1996.

In the present invention, any synthetic resin material can be used as long as it is conventionally used in the formation of a surface layer (protective layer) and has a glass transition temperature of from 0 to 45° C. Examples thereof include acrylic rubber, acrylic styrene resin, urethane resin, polyamide resin, polyester resin, fluorine resin, acrylic silicone resin, butyral resin, alkyd resin, and fluorine-modified acrylate resin. Any one of theses known synthetic rubber materials having a glass transition temperature of from 0 to 45° C. may be used alone, or any combination of theses known synthetic rubber materials having a glass transition temperature of from 0 to 45° C. may be used.

The above-described conductive agent is added to the synthetic resin material such that the surface layer (16) has a volume resistivity of, in general, from about 1×10⁵ to 1×10¹³ Ω·cm. It is preferable that the synthetic resin material and conductive agent, and further various additives which will be described later, are added to the solvent and are mixed to obtain the synthetic resin composition in a liquid form. When the synthetic resin composition that forms the surface layer (16) is in a liquid form, the synthetic resin composition effectively enters (are contained) in openings of the electrically conductive rubber foam layer (14). As a result, adhesion between the surface layer (16) and the electrically conductive rubber foam layer (14) can be effectively secured. Examples of the solvents used in the preparation of the synthetic resin composition include water, methanol and the like.

To the synthetic resin composition used in the formation of the surface layer (16), various additives such as a known cross-linking agent, a roughening agent such as urethane resin particles and a filler are added in the same ratio as in the conventional manner. Due to the formation of the surface layer (16) by such a synthetic resin composition, the electrically conductive rubber foam layer (14) is protected, and abrasion resistance and the like can be highly secured.

The charging roll of the present invention as shown in FIG. 1 can be produced according to the following method, for example.

Initially, an unvulcanized, unfoamed rubber layer which gives the electrically conductive rubber foam layer 14 is prepared by using the above foamable conductive rubber composition. Specifically, the foamable conductive rubber composition is formed into a tube.

When forming the foamable conductive rubber composition into a tube, any conventionally known forming methods such as an extrusion method and a molding method may be employed. In the view of productivity and the like, an extrusion method is advantageously employed. In the extrusion method, an extruder which is generally used may be employed, or it may be possible to form an unvulcanized, unfoamed rubber layer directly on the outer circumferential surface of the center shaft 12 or another core material.

First, the unvulcanized, unfoamed rubber layer obtained as above, is heated under pressure to obtain a semi-vulcanized, unfoamed rubber layer having a skin layer 18 at a superficial layer thereof. Due to the heating under pressure, foam formation is inhibited in the unvulcanized, unfoamed rubber layer, while the vulcanization proceeds around the outer circumferential surface thereof. In the production of the charging roll according to the present invention, it is important to provide the skin layer 18 at first. In the unvulcanized, unfoamed rubber layer, by forming the skin layer 18 at first and then vulcanizing and foaming the unvulcanized, unfoamed rubber layer, an opening area ratio of the surface of the electrically conductive rubber foam layer 14 finally obtained can be easily made to be within a desired range. Meanwhile, it is difficult to inhibit the foam formation in a conventionally known method in which a center shaft and an unvulcanized, unfoamed rubber layer are coaxially disposed in a molding cavity of a cylindrical mold and the mold is heated to foam and vulcanize the unvulcanized, unfoamed rubber layer simultaneously. Thus, in the conventionally known method, it is extremely difficult to make the opening area ratio of the surface of the electrically conductive rubber foam layer (14) to be within a range of from 0.5 to 20%.

Here, the unvulcaniied, unfoamed rubber layer is preferable to be heated under pressure in a state in which the center shaft or another kind of core is inserted thereto. The reason is that, in the unvulcanized, unfoamed rubber layer, the heat is hard to be conducted to a portion around the center shaft 12 (a portion positioned in an inner side in a direction perpendicular to the axial direction thereof) and the skin layer can be advantageously formed only at a superficial layer (a portion positioned in an outer side in a direction perpendicular to the axial direction thereof).

Various conditions for the heating under pressure, such as a pressurized condition, a heating temperature, a heating period and the like, are suitably determined depending upon the kinds and amounts of the vulcanizing agent and the vulcanization accelerator contained in the foamable conductive rubber composition such that the vulcanization of the unvulcanized, unfoamed rubber layer does not finish completely (such that the unvulcanized, unfoamed rubber layer is semi-vulcanized) and such that the opening area ratio is within a predetermined ratio (from 0.5 to 20%) by the heating under pressure, which will be described later. Generally, about 0.5 to 30 MPa, preferably 1 MPa is employed as a pressure condition. If the pressure is less than 0.5 MPa, it may be difficult to effectively control foaming of the foaming agent. On the other hand, if the pressure is more than 30 MPa, it may be difficult to control the condition of the foaming occurred in the unvulcanized, unfoamed rubber layer. Further, it is preferable that the unvulcanized, unfoamed rubber layer is heated at a temperature of about 120 to 250° C., preferably about 140 to 170° C., for about 5 to 3000 seconds, preferably for about 900 seconds (about 15 minutes). Furthermore, when heating under pressure, a pressure oven and the like can be used. Under such conditions, the skin layer 18 generally having a thickness of 10 to 100 μm is formed at the superficial layer of the semi-vulcanized, unfoamed rubber layer.

Secondly, a heat treatment under ordinary pressure is conducted on the semi-vulcanized, unfoamed rubber layer including the skin layer at the superficial layer thereof to obtain the electrically conductive rubber foam layer 14 including the skin layer having an opening area ratio of from 0.5 to 20% at the superficial layer of the electrically conductive rubber foam layer 14. Due to the heating under ordinary pressure, the foam formation and the vulcanization proceed in the semi-vulcanized, unfoamed rubber layer, thereby effectively allowing the skin layer 18 to have openings. Like the heating under pressure, various conditions for the heating under ordinary pressure (for example, a heating temperature and a heating period) are suitably determined. Generally, the heating temperature of about 150° C. and the heating period of about 30 minutes are employed.

Thirdly, on a surface of the above-described electrically conductive rubber foam layer 14 including the skin layer 18 having an opening area ratio within a predetermined range, the surface layer 16 is formed by using the above-described synthetic resin composition. Specifically, when the synthetic resin composition prepared in a liquid form is used, the synthetic resin composition is applied on a surface of the electrically conductive rubber foam layer 14 according to any conventionally known method, for example, a roll coating method. Then, the surface layer 16 is obtained by drying (and heating as needed) the coated film. The surface layer 16 is formed to have a thickness of preferably from 1 to 50 μm, more preferably from 1 to 20 μm.

In the charging roll 10 of the present invention produced according to the above method, the electrically conductive rubber foam layer 14 includes the skin layer 18 having a predetermined opening area ratio at a superficial layer thereof, and the surface layer 16 formed on the outer surface of the electrically conductive rubber foam layer 14 is formed of the synthetic rubber composition mainly composed of a predetermined synthetic resin. As a result, defects in the printed image may not be caused even if the charging roll 10 is used for a long period of time. Further, the surface layer 16 of the charging roll 10 may not be separated even if the electrophotographic machine is operated after the charging roll 10 is left under high temperature and humidity conditions while it is installed in an electrophotographic machine (in a cartridge).

### EXAMPLES

To further clarify the principle of the present invention, several examples of the present invention will be described below. However, it is to be understood that the invention is by no means limited to the details of these examples, but may be embodied with various changes, modifications and improvements which may occur to those skilled in the art, without departing from the scope of the present invention.

Initially, five kinds of foamable conductive rubber compositions (A to E) were prepared, so as to have the respective compositions as indicated in the following Table 1. In the preparation of each composition, the following rubber material and agents are used.

Epichlorohydrin rubber: EPICHLOMER CG102 (product name), available from DAISO CO., LTD.

Quaternary ammonium salt: tetramethylammonium perchlorate

Zinc oxide: zinc oxide type 2 (product name), available from Sakai Chemical INDUSTRY Co., Ltd.

Azodicarbonamide: cellmic RUB (product name), available from SANKYO KASEI CO., LTD.

Sulfur: sulfur powder, available from Tsurumi Chemical Industry Co., Ltd.

Vulcanization accelerator A: NOCCELER DM (product name), available from OUCHI SHINKO CHEMICAL INDUSTRIAL CO., LTD.

Vulcanization accelerator B: NOCCELER TS (product name), available from OUCHI SHINKO CHEMICAL INDUSTRIAL CO., LTD.

Vulcanization accelerator C: NOCCELER CZ (product name), available from OUCHI SHINKO CHEMICAL INDUSTRIAL CO., LTD.

TABLE 1

| | | Foamable conductive rubber composition | | | | |
|---|---|---|---|---|---|---|
| | | (Formation material of an electrically | | | | |
| | | conductive rubber foam layer) | | | | |
| | | A | B | C | D | E |
| Composition | Epichlorohydrin rubber | 100 | 100 | 100 | 100 | 100 |
| (Parts by | Quaternary ammonium salt | 1 | 1 | 1 | 1 | 1 |
| weight) | Zinc oxide | 5 | 5 | 5 | 5 | 5 |
| | Azodicarbonamide | 10 | 10 | 10 | 10 | 10 |
| | Sulfur | 1 | 1 | 1 | 1 | 1 |
| | Vulcanization accelerator A | 1.5 | 1 | 0.5 | — | — |
| | Vulcanization accelerator B | 1 | 1 | 1 | 1 | 1 |
| | Vulcanization accelerator C | — | 0.5 | 1 | 1.5 | 1 |

Further, components indicated in the following Table 2 were added to 300 parts by weight of water as a solvent, and dispersed therein. Thus, seven kinds of synthetic resin compositions (a to g), which work as a formation material of the surface layer, were prepared. In the preparation of each composition, the following synthetic resin materials and agent were used.

Acrylic resin 1: VONCOAT CP-6190 (product name), available from DIC corporation

Acrylic resin 2: VONCOAT SA-6360 (product name), available from DIC corporation

Acrylic resin 3: VONCOAT 550EF (product name), available from DIC corporation

Acrylic resin 4: BURNOCK WE-304 (product name), available from DIC corporation

Acrylic resin 5: VONCOAT VF-1040 (product name), available from DIC corporation

Urethane resin: TAKELAC W-6061 (product name), available from Mitsui Chemicals Polyurethanes, Inc.

Acrylic styrene resin: VONCOAT CG-8400 (product name), available from DIC corporation

Carbon black: Ketjen Black EC300J (product name), available from Ketjen Black International Company

TABLE 2

| | | Synthetic resin composition | | | | | | |
|---|---|---|---|---|---|---|---|---|
| | | (Formation material of a surface layer) | | | | | | |
| | | a | b | c | d | e | f | g |
| Composition | Acrylic resin 1 | 100 | — | — | — | — | — | — |
| (Parts by | Acrylic resin 2 | — | 100 | — | — | — | — | — |
| weight) | Acrylic resin 3 | — | — | 100 | — | — | — | — |
| | Acrylic resin 4 | — | — | — | 100 | — | — | — |
| | Acrylic resin 5 | — | — | — | — | 100 | — | — |
| | Urethane resin | — | — | — | — | — | 100 | — |
| | Acrylic styrene resin | — | — | — | — | — | — | 100 |
| | Carbon black | 8 | 8 | 8 | 8 | 8 | 8 | 8 |

The foamable conductive rubber composition (formation material of an electrically conductive rubber foam layer) and the synthetic resin composition (formation material of a surface layer) prepared as above were used to produce charging rolls in accordance with the following method.

Together with a core material having a diameter of 4 mm and made of SUS304, the foamable conductive rubber composition was extruded, by using an extruder including a crosshead and an extrusion die having a diameter of 40 mm, thereby obtaining a complex having an unvulcanized, unfoamed rubber layer on an outer circumferential surface of the core material.

The obtained complex was disposed in a pressure oven and the pressure in the oven was increased to 1 MPa. Then, the temperature in the oven was increased to the temperature indicated in the following Table 3 and Table 4, and the complex was subjected to a heat treatment for 15 minutes. After the heat treatment, the surface of the complex (surface of the semi-vulcanized, unfoamed rubber layer) was visually observed. As a result, no foamed cell was observed and it was confirmed that the skin layer was formed.

Then, the pressure in the oven was decreased to the ordinary pressure and the core material was removed from the complex. The resultant rubber tube (the semi-vulcanized, unfoamed rubber layer) was subjected to a heat treatment in the oven at 150° C. for 30 minutes under ordinary pressure.

Into the foamed rubber tube (the electrically conductive rubber foam layer) obtained as above, a center shaft was inserted to obtain a base roll. Then, a synthetic resin composition (formation material of a surface layer) was applied onto the surface of the base roll according to a roll coating method and was dried to form a surface layer (thickness of 10 μm). Accordingly, a charging roll was obtained.

According to the above method, a total of 18 kinds of charging roll (Examples 1 to 13, Comparative Examples 1 to 5) were produced.

The following Table 3 and Table 4 show 1) kinds of the foamable conductive rubber composition (formation material of the electrically conductive rubber foam layer) and the synthetic resin composition (formation material of the surface layer), 2) heating temperatures in the formation of the electrically conductive rubber foam layer under pressure and ordinary pressure, 3) opening area ratios (%) of the electrically conductive rubber foam layers, and 4) glass transition temperatures (° C.) of the synthetic resins in the synthetic resin compositions (formation material of the surface layer). Here, the opening area ratio of the electrically conductive rubber foam layer was calculated according to the above-described manner after the surface thereof was observed by using a laser microscope (product name: VIOLET LASER COLOR 3D PROFILE MICROSCOPE VK-3500, available from KEYENCE CORPORATION).

The 18 kinds of charging rolls (Examples 1 to 13, Comparative Examples 1 to 5) produced as above were evaluated as below.

—Evaluation of Adhesion to the Photosensitive Drum—

The produced charging roll was actually installed in a toner cartridge of a printer (product name: Laser Jet 3800dn available from Hewlett-Packard Japan, Ltd.) and left under an environment of 32.5° C.×85% RH for 30 days. Then, the toner cartridge was taken apart and it was examined if the surface layer of the charging roll was separated or not when the roll was removed from the cartridge. Then, the charging rolls were evaluated according to the following criteria. “Good” denotes that no adhesion was observed, more specifically, a part of the surface layer of the charging roll that contacted with the photosensitive drum did not separate when removing the charging roll. Meanwhile, “Poor” denotes that adhesion was observed, more specifically, a part of the surface layer of the charging roll separated when removing the charging roll. The evaluation results are shown in the following Table 3 and Table 4 under the heading of “adhesion to the photosensitive drum”.

—Evaluation of the Printed Image (Undesirable Dots)—

The charging roll was actually installed in a toner cartridge of a printer (product name: Laser Jet 3800dn available from Hewlett-Packard Japan, Ltd.) and a 25% half tone image was printed under an environment of 23° C.×53% RH. Then, the printed image was evaluated according to the following criteria. The evaluation results of the charging rolls are shown in the following Table 3 and 4 under the heading of “image with undesirable dots”.

Good: no dots were observed in the image printed by one rotation of the charging roll.

Average: some dots were observed in the image printed by one rotation of the charging roll, but it is in an acceptable range.

Poor: many dots were observed in the image printed by one rotation of the charging roll.

—Evaluation of the Printed Image after the Endurance Test—

The charging roll was actually installed in a toner cartridge of a printer (product name: Laser Jet 3800dn available from Hewlett-Packard Japan, Ltd.) and subjected to an endurance test in which 6000 sheets were printed based on 5% toner coverage under an environment of 32.5° C.×85% RH. After the endurance test, a 25% half tone image was printed and it was visually observed if undesirable lines extending in a direction corresponding to a circumferential direction of the roll were appeared in the printed image or not. Then, the charging rolls were evaluated according to the following criteria. “Good” denotes that no undesirable lines were appeared, and “Poor” denotes that undesirable lines were appeared. The evaluation results are shown in the following Table 3 and Table 4 under the heading of “Image defects after the endurance test”.

TABLE 3

| | | Examples | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| Electrically | Material | C | C | C | C | C | D | B | B | C | C | B | B | B |
| conductive | Heating temperature | 150 | 150 | 150 | 160 | 140 | 150 | 150 | 150 | 150 | 150 | 160 | 165 | 165 |
| rubber foam | under pressure [° C.] | | | | | | | | | | | | | |
| layer | Heating temperature | 150 | 150 | 150 | 150 | 150 | 150 | 150 | 150 | 150 | 150 | 150 | 150 | 150 |
| | under ordinary pressure [° C.] | | | | | | | | | | | | | |
| | Opening area ratio [%] | 14 | 14 | 14 | 8 | 18 | 20 | 5 | 5 | 14 | 14 | 2 | 0.5 | 0.5 |
| Surface layer | Material | a | b | c | c | c | b | b | c | f | g | c | c | a |
| | Glass transition temperature | 45 | 19 | 0 | 0 | 0 | 19 | 19 | 0 | 27 | 24 | 0 | 0 | 45 |
| | of synthetic resin [° C.] | | | | | | | | | | | | | |
| Evaluation | Adhesion to photosensitive drum | Good | Good | Good | Good | Good | Good | Good | Good | Good | Good | Good | Good | Good |
| | Image with undesirable dots | Good | Good | Good | Good | Average | Average | Good | Good | Good | Good | Good | Good | Good |
| | Image defect after endurance test | Good | Good | Good | Good | Good | Good | Good | Good | Good | Good | Good | Good | Good |

TABLE 4

| | | Comparative Examples | | | | |
|---|---|---|---|---|---|---|
| | | 1 | 2 | 3 | 4 | 5 |
| Electrically | Material | A | A | E | D | D |
| conductive | Heating temperature | 150 | 150 | 150 | 150 | 150 |
| rubber foam | under pressure [° C.] | | | | | |
| layer | Heating temperature | 150 | 150 | 150 | 150 | 150 |
| | under ordinary pressure [° C.] | | | | | |
| | Opening area ratio [%] | 0 | 0 | 25 | 20 | 20 |
| Surface layer | Material | d | a | a | e | d |
| | Glass transition temperature | 75 | 45 | 45 | −11 | 75 |
| | of synthetic resin [° C.] | | | | | |
| Evaluation | Adhesion to photosensitive drum | Good | Poor | Good | Poor | Good |
| | Image with undesirable dots | Good | Good | Poor | Average | Average |
| | Image defect after endurance test | Poor | Good | Poor | Good | Poor |

As apparent from the results shown in Table 3 and Table 4, the charging roll according to the present invention did not cause image defects such as undesirable lines in the printed image even when the charging roll was used for a long period of time. Further, even when the charging roll was left under high temperature and humidity conditions for a long period of time while being installed in an electrophotographic machine, adhesion of the surface layer of the charging roll to the image-bearing medium such as a photosensitive drum was effectively prevented. Furthermore, during the operation of the electrophotographic machine, which was conducted subsequently to the above, the surface layer did not separate from the charging roll.

What is claimed is:

1. A charging roll comprising a shaft, an electrically conductive rubber foam layer formed on an outer circumferential surface of the shaft, and a surface layer formed radially outwardly of the electrically conductive rubber foam layer,
wherein the electrically conductive rubber foam layer includes a skin layer having an opening area ratio of from 0.5 to 20% at a superficial layer of the electrically conductive rubber foam layer, and the surface layer is formed of a synthetic resin composition mainly composed of a synthetic resin material having a glass transition temperature of from 0 to 45° C.

2. The charging roll according to claim 1, wherein the electrically conductive rubber foam layer is formed by heating a semi-vulcanized, unfoamed rubber layer under ordinary pressure, the semi-vulcanized, unfoamed rubber layer being obtained by heating an unvulcanized, unfoamed rubber layer under pressure.

3. The charging roll according to claim 1, wherein the synthetic resin composition is in a liquid form.

4. A method of producing a charging roll including a shaft, an electrically conductive rubber foam layer formed on an outer circumferential surface of the shaft, and a surface layer formed radially outwardly of the electrically conductive rubber foam layer, characterized by the steps of:
providing an unvulcanized, unfoamed rubber layer which gives the electrically conductive rubber foam layer,
heating the unvulcanized, unfoamed rubber layer under pressure to obtain a semi-vulcanized, unfoamed rubber layer including a skin layer at a superficial layer thereof,
heating the semi-vulcanized, unfoamed rubber layer under ordinary pressure to allow the skin layer to have openings, thereby obtaining the electrically conductive rubber foam layer including the skin layer having an opening area ratio of from 0.5 to 20% at the superficial layer of the electrically conductive rubber foam layer, and
forming the surface layer by a synthetic resin composition mainly composed of a synthetic resin material having a glass transition temperature of from 0 to 45° C., so as to be positioned radially outwardly of the electrically conductive rubber foam layer.
